(19) United States
(12) Patent Application Publication
(10) Pub. No.: US 2006/0213930 A1
(43) Pub. Date: Sep. 28, 2006

(54) Unit including a dispensing device and a fire protection element

(75) Inventor: Eric Issartel, Vouneuil sur Vienne (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 11/372,127

(22) Filed: Mar. 10, 2006

Related U.S. Application Data
(60) Provisional application No. 60/662,828, filed on Mar. 18, 2005.

(30) Foreign Application Priority Data
Mar. 10, 2005 (FR) 0550628

(51) Int. Cl. B67D 5/06

(52) U.S. Cl. 222/183

(57) ABSTRACT

A unit including at least one product dispensing device including a container holding the product to be dispensed and a propellant gas, and a valve enabling the product to be dispensed when it is actuated. A fire protection element at least partially surrounds the device, with the protective element including at least one textile layer.

### CROSS-REFERENCE TO RELATED APPLICATIONS

This document claims priority to French Application Number 05 50628, filed Mar. 10, 2005 and U.S. Provisional Application No. 60/662,828, filed Mar. 18, 2005, the entire contents of which are hereby incorporated by reference.

### FIELD OF THE INVENTION

The invention relates to a unit including at least one pressurized dispensing device and a fire protection element.

### BACKGROUND OF THE INVENTION

### Discussion of Background

Pressurized dispensing devices of the aerosol type contain gases under pressure which may be flammable. This is true of dimethyl ether, butane, isobutane, and also propane.

Before being distributed to stores, such devices are stored on pallets in a relatively large number. Such devices are already very well protected, in particular by their own structure, and also by the systems surrounding them. For example, the areas in which the dispensing devices are stored can be equipped with sprinklers to spray the devices in case of fire and to prevent the fire from spreading.

However, it is desirable to further improve the protection of the pressurized dispensing devices, for example in the case where fire breaks out in proximity thereto. In such an eventuality, the flames generated by such a fire can spread in an extremely violent and rapid manner. Furthermore, the handling of pallets by lift trucks equipped with a fork can cause piercing of the pressurized devices which may result in bursting and projectile expulsion of the pressurized devices exposed to the flames.

This is why there is a need to further protect the pressurized dispensing devices.

### SUMMARY OF THE INVENTION

It is an object of the invention to provide a unit which includes at least one pressurized dispensing device and which affords protection for the device against an external fire.

It is another object of the invention to provide such a unit which affords mechanical protection for the dispensing device.

According to the invention, these objects can be achieved by a unit including at least one product dispensing device, with a container holding the product to be dispensed and a propellant gas, together with a valve enabling the product to be dispensed when it is actuated. In addition, a fire protection element at least partially surrounds the device, with the protective element including at least one textile layer.

By using a fire protection element including at least one textile layer, i.e. which has a mesh structure in a preferred example, the protection against fire is optimized.

In effect, by virtue of its inherent properties or the treatment to which it is subjected, the mesh structure of the protective element protects the device against heat and flames when a fire spreads in proximity to the device. The textile can thus prevent the flames from reaching the dispensing devices.

In addition, when water is used to extinguish the fire, it can be, for example, by capillary action between the meshes, thereby further improving the resistance to fire.

Finally, if one or more of the dispensing devices are opened, for example if they are pierced, the gas escaping from the devices does not remain captive inside the protective element. The mesh structure effectively allows the gas to escape through the openings provided between the meshes thereby avoiding pressure buildup within the unit.

The protective element can also advantageously have mechanical strength properties in a preferred example. For example, tests have been carried out to show that the protective element does not tear when it is pierced by the fork of a lift truck traveling at a speed of 4 to 5 km/h. The protective element can thus be difficult to tear or pierce, thereby fully protecting the dispensing devices against external mechanical damage. This minimizes the risk of the devices being pierced by a fork of a lift truck for example, which could result in an escape of propellant gases which are then liable to ignite if a flame or a spark of mechanical, electrical or electrostatic origin is in proximity thereto.

In addition, by virtue of its mechanical strength, the protective element prevents the pressurized dispensing devices from being forcibly ejected from the unit. Thus, if a fire spreads inside the unit, the burning dispensing devices are prevented from being ejected over a distance of several meters which is liable to cause the fire to spread rapidly.

By way of example, the protective element can contain aramid or polybenzazole (PBO) fibers. In particular, the protective element can contain Kevlar® or Nomex® fibers, with these two materials being marketed by the company DuPont de Nemours. These materials have intrinsic properties of heat and fire resistance, as well as excellent mechanical strength.

Alternatively or additionally, the protective element may be subjected to a fire-proofing treatment.

The protective element can include several identical or different textile layers.

Also by way of example, at least one of the layers can have a padded structure. This has the effect of further improving the water retention capacity of the textile thereby further enhancing its fire resistance.

According to a further optional feature, the protective element can include a reflective layer, in particular a textile layer incorporating aluminum fibers, or a textile layer covered with aluminum. The protective element is thus able to reflect the radiant heat generated by the flames of a fire spreading in proximity to the unit thereby preventing the dispensing devices from overheating.

The protective element can be in the form of a slipcover. It can thus be readily fitted around the dispensing device so as to completely surround it.

In addition, the protective element can be extensible. It can thus be adapted to fit all the shapes of the devices to be protected.

The container can hold a cosmetic product. The expression “cosmetic product” is understood to mean a product such as defined in Council Directive 93/35/CEE dated 14th Jun. 1993, amending Directive 76/768/CEE for the sixth time.

The device can, for example, contain a skincare product, a makeup product, a body hygiene product, a haircare product or a sunscreen product.

The unit can include several dispensing devices arranged on a pallet provided for the transportation thereof, i.e., a loading surface.

The devices can be contained in cartons placed on the pallet.

Additionally, or alternatively, the protective element can be fitted over the pallet and all of the dispensing devices. It is thus possible to dispense with the use of stretch film which is generally wrapped around the pallets.

The protective element can be attached to the pallet, in particular by means of clips or straps.

The protective element can thus curb the theft of dispensing devices when the pallets are being stored or transported.

The pallet can include at least one opening configured to receive a fork of a lift truck, with the opening being accessible from the outside when the protective element is attached to the pallet.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

A clearer understanding of the invention will be gained from reading the following description in conjunction with the accompanying figures. The figures are offered purely as a guide and in no way limit the invention.

FIG. 1 illustrates a perspective view of a dispensing device of the unit according to the invention;

FIG. 2 illustrates a perspective view of a preferred embodiment of a unit according to the invention including several devices as depicted in FIG. 1 before assembly of additional cases onto the pallet and application of the protective element to the unit;

FIG. 3 illustrates the unit in FIG. 2 with a protective element in the assembled position; and

FIG. 4 illustrates a second embodiment of a unit according to the invention.

### DETAILED DESCRIPTION OF THE PREFERRED EMBODIMENTS

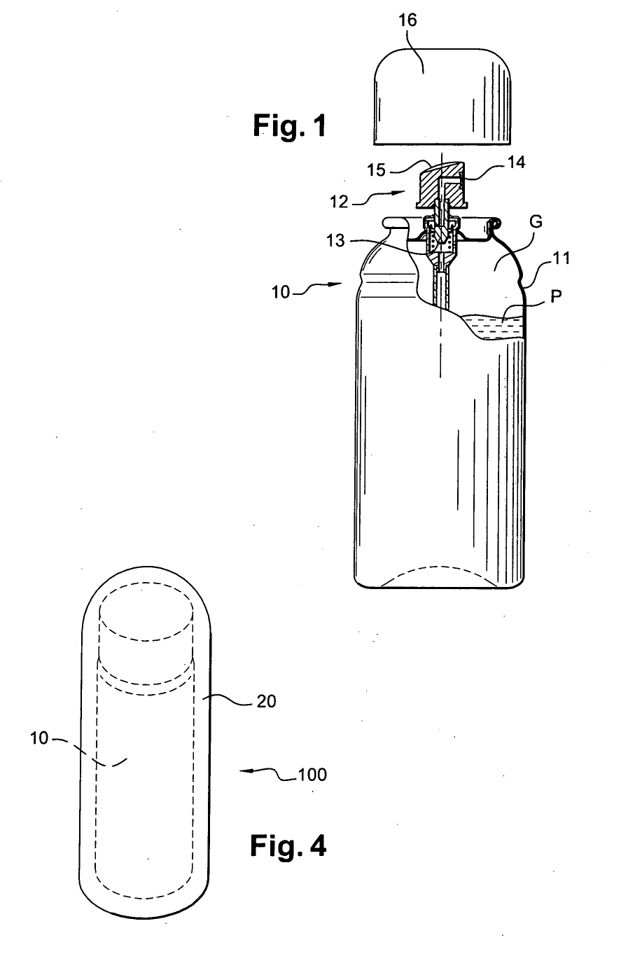

Referring now to the drawings, by way of example, the dispensing device 10 shown in FIG. 1 includes a container 11 of cylindrical shape, in particular made of aluminum or tin. As a variant, the container can have any other shape. It can also be made of a thermoplastic material.

In the illustrated example, the container 11 is surmounted by a dispensing head 12 designed to actuate a valve 13 mounted on the container 11, and to dispense the product via an outlet aperture 14. The valve is actuated via a bearing surface 15 disposed on the dispensing head. The valve can be of the push-down or tilting type (tilt valve).

The device 10 can include a detachable cap 16 designed to be mounted with a light friction fit on the dispensing head 12, thereby protecting it from the external environment when the device is in the storage position.

A cosmetic product P is packaged in the container 11. The product P can be in the form of a liquid, a foam, or a more viscous consistency, in particular in the form of a cream or a gel. The product P can be a skincare product, a makeup product, a haircare or bodily hygiene product, or a sunscreen product.

The product P is pressurized by means of a propellant gas G, liquefied or otherwise. The gas can be packaged directly in contact with the product as illustrated in FIG. 1, or separately via a piston or a flexible-wall pocket.

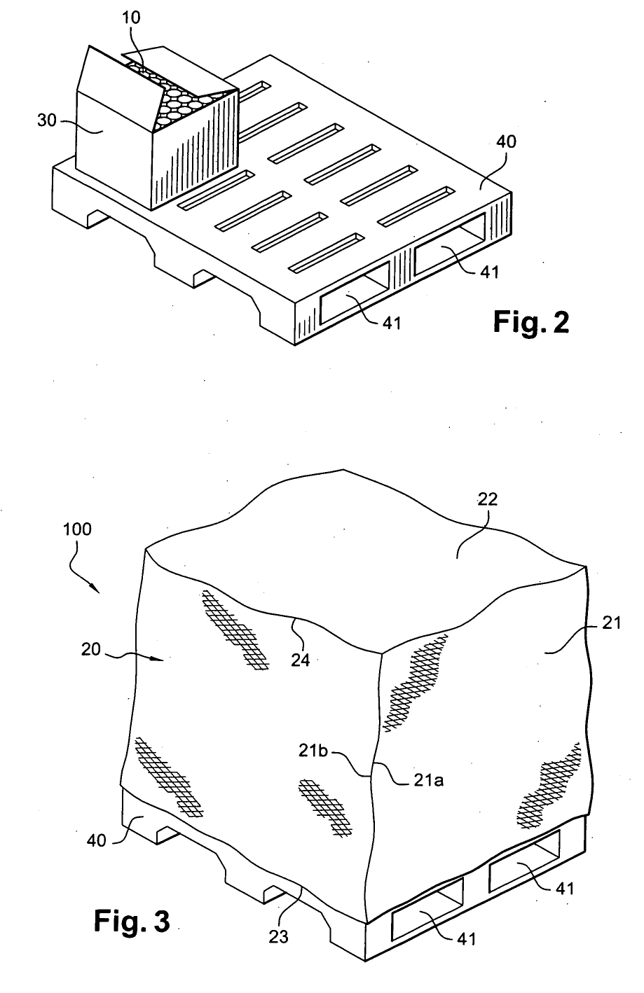

As can be seen in FIG. 2, several dispensing devices 10 are packaged in a carton 30 designed to be delivered to a point of sale.

Several cartons 30 are stacked on a pallet 40, i.e. a loading surface, thereby facilitating movement of the cartons, it being thus possible to move several cartons at the same time.

According to an example of the invention, the pallet loaded with several cartons is covered by a protective element 20 which protects the unit against fire and also against mechanical damage. For example, FIG. 3 shows a protective element 20 in the form of a slipcover which fits over the pallet 40 loaded with cartons 30 filled with pressurized dispensing devices 10.

By way of example, the slipcover 20 takes the form of an open envelope into which the pallet loaded with cartons can be inserted.

The slipcover 20 is, for example, made from a first rectangular portion 21 of elongated shape of which the ends 21a and 21b are fixed together so as to form the sidewalls of the slipcover, the bottom edge 23 of this sidewall delineating the opening in the slipcover. The ends 21a and 21b are for example stitched, welded or glued together. The upper edge 24 of the sidewall 21 is connected to a second rectangular portion which is attached, over its entire periphery, to the edge 24 of the sidewall so as to form the topside of the slipcover opposite the opening.

As a variant, the slipcover can be formed solely by one rectangular portion of elongated shape of which the ends 21a and 21b are attached together, and the upper edge 24 of which is gathered and attached to itself.

The slipcover can of course be made differently and can also have any other shape, the shape obviously being chosen in relation to the item to be protected.

Such a slipcover is flexible so that it can be readily fitted over the pallet loaded with cartons.

In the example illustrated in FIGS. 2 and 3, the lower edge 23 of the protective slipcover 20 is attached to the pallet 40, above the openings 41, so as to facilitate the passage of the fork of a lift truck.

The unit 100 can thus be stored in a storage area and can be transported by means of a lift truck.

The protective slipcover 20 is composed of at least one layer of a fiber-based textile with fire-proofing properties. In particular, by way of example, aramid fibers or polybenzazole fibers can be used. The term aramid designates any synthetic fiber in which the base polymer is composed of the amide-NC-CO group, of which at least 85% is directly bonded to two aromatic cores, while the term polybenzazole designates high-performance fibers belonging to the family of polymers containing an aromatic heterocycle. Kevlar® or Nomex® fibers may be chosen for example, with these two materials being marketed by the company DuPont de Nemours.

In a particular example, the protective slipcover 20 can be made of a textile according to any one of the examples described in patent application FR 2 822 650, incorporated herein by reference.

The slipcover 20 includes several layers of textile for example. The mechanical protection of the slipcover is thus enhanced in that the different layers will absorb a large amount of energy, during impacts for example, so that the impacts do not reach the devices, or at least do so with less violence.

In addition, the ability of the slipcover to retain water, for example, by capillary action and/or other retention properties is increased.

The different layers of textile can be composed of fibers of different types or having different types of weave.

At least one of the layers can have a padded structure in which water can be retained by capillary action or other phenomena.

At least one of the layers can be subjected to a fire-proofing treatment to further increase the heat and flame resistance of the slipcover.

In addition, the slipcover can incorporate aluminum fibers enabling it to reflect the radiant heat generated by the flames of a fire spreading in proximity to the unit thereby preventing the dispensing devices from overheating.

Instead of using aluminum fibers, one of the layers can be lined with an aluminum film.

Labels carrying information relating to the devices 10 protected by the slipcover can be affixed to the external surface of the slipcover.

In another embodiment, it is possible to use slipcovers 20 configured to surround a single pressurized dispensing device. An example of such a unit 100 is depicted in FIG. 4. As a variant, the slipcover 20 can protect two or more aerosol devices 10 by holding them together by virtue of its extensibility. The provision of a core about individual or multiple containers can be an alternate or in addition to a cover for an entire pallet and/or a case/carton of dispensing devices. Unless specified otherwise, as used herein, reference to the fire protection element surrounding or partially surrounding the dispensing device encompasses both the situation in which the fire protection element is in direct contact with the dispensing device and also (or alternatively) the situation in which there are intermediate packaging or shipping materials between the fire protection element and the dispensing device (e.g., cartons of a pallet wrapped with the fire protection element).

Instead of being in the form of a slipcover, the protective element 20 can be composed of a simple cover, for example rectangular, circular or any other shape. Such a cover can be used to cover a single pallet loaded with cartons or several pallets at the same time, or to directly cover one or more devices 10 that are not packed in cartons.

In the foregoing detailed description reference is made to preferred embodiments of the invention. It is evident that variants thereto can be proposed without departing from the invention as claimed herebelow.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A unit including:
at least one product dispensing device, said product dispensing device including a container holding the product to be dispensed and a propellant gas, and a valve enabling the product to be dispensed when the valve is actuated; and
a fire protection element at least partially surrounding the device, the protection element including at least one textile layer.

2. A unit according to claim 1, wherein the fire protection element has mechanical strength properties.

3. A unit according to claim 1, wherein the protection element contains aramid or polybenzazole fibers.

4. A unit according to claim 1, wherein the protection element is extensible.

5. A unit according to claim 1, wherein the protection element includes a plurality of textile layers.

6. A unit according to claim 5, wherein said plurality of textile layers are identical to each other.

7. A unit according to claim 5, wherein said plurality of textile layers are different from each other.

8. A unit according to claim 5, wherein at least one of the layers includes a padded structure.

9. A unit according to claim 8, wherein the protection element includes a reflective layer, comprising a textile layer having aluminum fibers.

10. A unit according to claim 1, wherein the protection element includes a reflective layer, comprising a textile layer having aluminum fibers.

11. A unit according to claim 1, wherein the protection element is in the form of a slipcover.

12. A unit according to claim 11, wherein the container holds a cosmetic product.

13. A unit according to claim 12, wherein the unit includes a plurality of dispensing devices arranged on a pallet provided for the transportation thereof.

14. A unit according to claim 13, wherein the dispensing devices are contained in a plurality of cartons placed on the pallet.

15. A unit according to claim 14, wherein the protection element fits over all of the dispensing devices of the pallet.

16. A unit according to claim 13, wherein the protection element fits over all of the dispensing devices of the pallet.

17. A unit according to claim 16, wherein the protection element is attached to the pallet.

18. A unit according to claim 17, wherein the pallet includes at least one opening configured to receive a fork of a lift truck.

19. A unit according to claim 18, wherein the opening is accessible from outside of the pallet when the protection element is attached to the pallet.

20. A unit according to claim 1, wherein the unit includes a plurality of dispensing devices arranged on a pallet for the transportation thereof, and wherein the protection element surrounds all of the dispensing devices of the pallet.

21. A unit according to claim 1, wherein said protection element is in contact with said container.

22. A unit according to claim 21, wherein said unit includes a plurality of said dispensing devices arranged on a pallet for transportation thereof.
